(19) United States
(12) Patent Application Publication
(10) Pub. No.: US 2007/0028587 A1
(43) Pub. Date: Feb. 8, 2007

(54) Turbine powered flywheel

(76) Inventor: Jerome Andrew Steers, Miami, FL (US)

Correspondence Address: MALLOY & MALLOY, P.A., 2800 S.W. Third Avenue, Historic Coral Way, Miami, FL, 33129, US

(21) Appl. No.: 11/544,673

(22) Filed: Oct. 6, 2006

Related U.S. Application Data
(63) Continuation-in-part of application No. 10/464,093, filed on Jun. 18, 2003, now abandoned.

(51) Int. Cl. F02C 3/00

(52) U.S. Cl. 60/39.01; 74/572.2

(57) ABSTRACT

An inexpensive, and easily adaptable energy recovery/storage device, namely a turbine powered flywheel assembly structured to capture, store, and deliver reusable energy that is traditionally wasted by internal combustion engines via a power output shaft that extends from a support bearing oriented on the central axis of a flywheel. The flywheel is driven by a driving assembly that includes a turbine driven shaft structured with gear teeth and oriented to come into enmeshing contact with the flywheel. A protective casing surrounds the flywheel to at least partially protect the flywheel from unwanted obstructions.

### CLAIM OF PRIORITY

The present application is a continuation-in-part application of previously filed, now pending application having Ser. No. 10/464,093, filed on Jun. 18, 2003 incorporated herein by reference.

### BACKGROUND OF THE INVENTION

1. Field of the Invention

The present invention is directed to an energy recovery/storage device, more specifically, a turbine powered flywheel assembly connected to a power output assembly and structured to provide a highly efficient and effective source of driving power which is substantially scaleable, is minimally susceptible to malfunction, and utilizes otherwise wasted energy from fuel combustion.

2. Description of the Related Art

Present day internal combustion engines typically waste more then sixty (60) percent of the energy from the fuel that is utilized to power the engine. The drawbacks are obvious and thus the need for a simple, inexpensive, and easily applied energy recovery/storage device to recover the wasted energy is substantial.

The current energy recovery devices available are costly, cumbersome, and not easily adaptable to suit multiple applications. For example, current energy recovery devices are comprised of interactions between multiple shafts, pinions, and gears used to drive a flywheel. Accordingly, efficiency is thus reduced and cost is increased.

Therefore it would be beneficial to provide a simple, inexpensive, and easily adaptable energy recovery/storage device for use in an internal combustion engine to save energy and improve fuel economy. The simple, inexpensive, and easily adaptable energy recovery/storage device would also reduce air pollution that is caused by the current internal combustion engines used today. It would also be beneficial to provide a turbine powered flywheel that is easy and economical to manufacture and apply to multiple variations of internal combustion engines.

A simple, inexpensive, and easily adaptable energy recovery/storage device would obtain some of the wasted heat and kinetic energy in the exhaust of an internal combustion engine from a turbine affixed to a shaft that would rapidly rotate a flywheel in a protective casing, thereby providing the ability to deliver significant amounts of energy through a power output assembly to the engine or drive train of a mobile vehicle or other device utilizing an internal combustion engine.

The stored energy from a simple, inexpensive, and easily adaptable recovery/storage device could be used to assist either a stationary power producing internal combustion engine in periods of peak load, or an internal combustion engine mounted in an automobile or other vehicle. The turbine powered flywheel may assist the internal combustion engine mounted in a vehicle by using less stress on the existing engine, thereby reducing engine wear and increasing fuel economy.

### SUMMARY OF THE INVENTION

The present invention is directed to an energy recovery/storage device, namely, a turbine driven flywheel assembly having a circular flywheel protected by a protective casing, a driving assembly, a rotating assembly, a power output assembly, and a turbine.

The flywheel of the present invention is preferably circular in shape having gear teeth oriented in spaced relation around at least part of the outer circumference of the flywheel. Moreover, the flywheel of the preferred embodiment of the present invention is composed of any material durable enough to engage the driving assembly though the use of the gear teeth and be able to withstand rotation at high speeds.

The driving assembly of the present invention preferably comprises a turbine driven shaft, having gear teeth oriented in spaced relation around at least a portion of the outer circumference of one end. As such, the gear teeth on both the flywheel and the driving assembly are structured and oriented to come into enmeshing contact with each other to enable rotation of the flywheel.

Included as part of the power output assembly of the present invention is a power output shaft connected to the rotating assembly. Specifically, the rotating assembly of the preferred embodiment of the present invention comprises a support bearing oriented on the central axis of the turbine driven flywheel. Preferably, the stored energy is distributed to an internal combustion engine through the power output shaft of the power output assembly.

Additionally, the turbine driven shaft is connected to a turbine. The turbine supplies the power and rotating force for the turbine driven shaft. Preferably, the turbine includes an exhaust intake which is connected to the exhaust output port of an internal combustion engine. The turbine is preferably structured to be driven by the exhaust air emitted by the exhaust output port of an internal combustion engine.

These and other objects, features and advantages of the present invention will become more clear when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a front plan view of one preferred embodiment of a turbine powered flywheel assembly in accordance with the present invention.

FIG. 2 is a close-up view of the turbine driven shaft connected to the turbine, and enmeshed with the flywheel in accordance with one preferred embodiment of the present invention.

Like reference numerals refer to like parts throughout the several views of the drawings.

### DETAILED DESCRIPTION OF THE PREFERRED EMBODIMENT

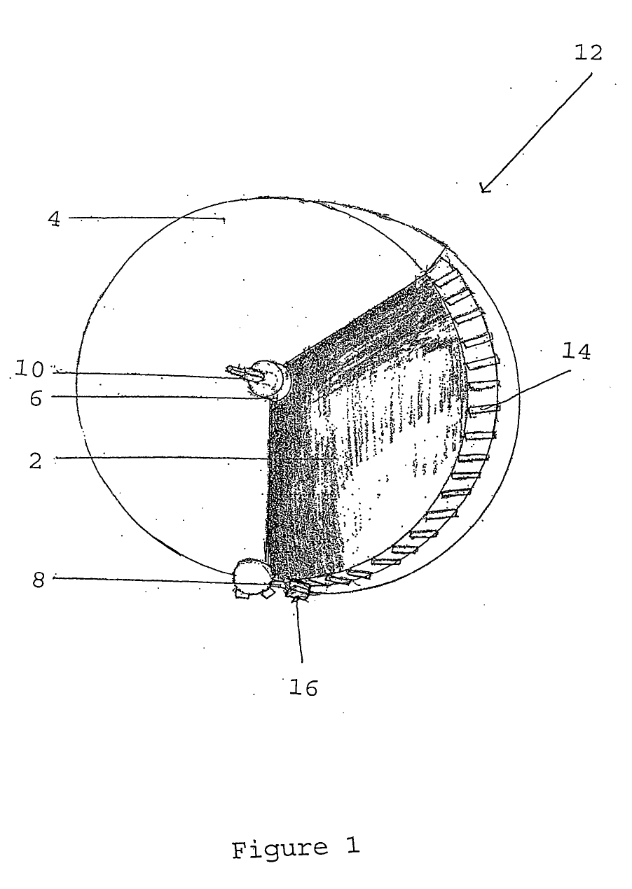

As stated above, the present invention is directed to an energy recovery/storage device, namely, a turbine powered flywheel assembly, generally as shown as 12 in FIG. 1. The turbine powered flywheel assembly 12 of the present invention includes at least one flywheel 2, which is preferably generally circular in shape and formed of a substantially rigid material. Disposed around at least a portion, but preferably the entire perimeter of the flywheel 2 is a plurality of gear teeth 14. The gear teeth 14 are also preferably rigid and durable, and are effectively secured to the flywheel 2 so as to impart rotation thereof when engaged. Along these lines, the gear teeth 14 may preferably be integrally formed with the flywheel 2.

Disposed at least partially around the flywheel 2 is a protective casing 4. The protective casing 4 is disposed to at least partially protect the flywheel 2 from unwanted obstructions, while still permitting the necessary engagement and interaction between the various components.

The turbine powered flywheel assembly 12 of the present invention further comprises a driving assembly 24. The driving assembly 24 is structured and disposed to come into enmeshing contact with the flywheel 2, and to therefore control the rotation of the flywheel 2. Moreover, in the preferred embodiment of the present invention the driving assembly 24 comprises a turbine driven shaft 8 having a plurality of gear teeth 16. The gear teeth 16 are preferably oriented and disposed in spaced relation around at least a portion of the circumference of one end of the shaft. Further, the gear teeth 16 are also preferably rigid and can be secured to the shaft in any means appropriate, including integral formation, such that rotation thereof corresponds to rotation of the shaft. Additionally, the gear teeth 16 are disposed in enmeshing contact with gear teeth 14 of the flywheel 2. Accordingly, when the turbine driven shaft 8 of the driving assembly 24 is rotated by a turbine 18, the gear teeth 16 on the turbine driven shaft 8 of the driving assembly 24 come into enmeshing contact with the gear teeth 14 on the flywheel 2 and cause rotation of the flywheel 2.

The turbine powered flywheel assembly 12 of the present invention further comprises a power output assembly 10. The power output assembly 10 is structured and disposed to output the energy. Preferably, the power output assembly 10 of the preferred embodiment of the present invention comprises a power output shaft oriented through a support bearing 6 at the central axis of the flywheel 2. As such, rotation of the flywheel 2 results in corresponding rotation of the power output shaft of the power output assembly 10. Along these lines, the power output shaft can be integrally formed or otherwise secured to the flywheel 2 such that corresponding relative movement there between is achieved.

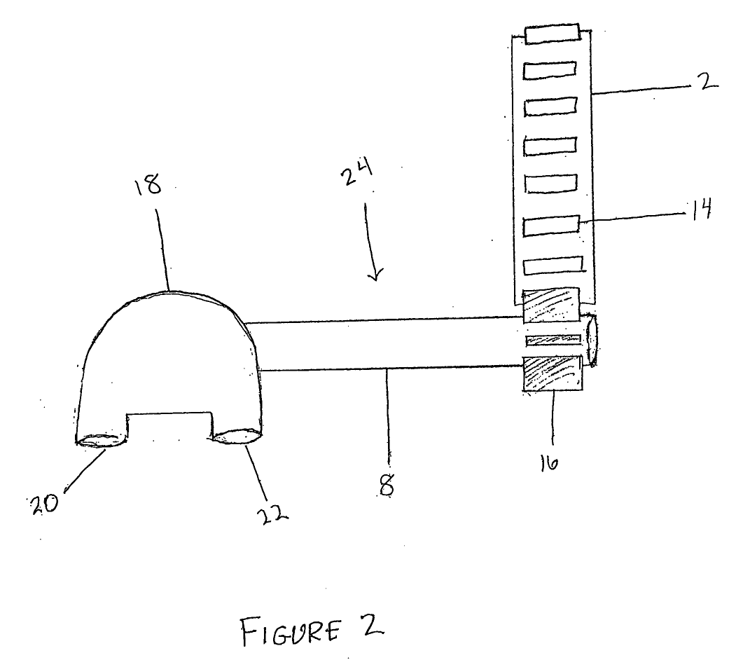

Referring to FIG. 2, the turbine powered flywheel 12 of the present invention is preferably powered by a turbine 18. The turbine 18 in the preferred embodiment of the present invention includes an exhaust intake 20 and an output port 22. Additionally, the turbine driven shaft 8 is attached to the turbine 18 to facilitate rotation of the turbine driven shaft 8. In the preferred embodiment of the present invention, the exhaust output port of an internal combustion engine is attached to the exhaust intake 20 of the turbine 18. Specifically, the energy provided by the exhaust output port of an internal combustion engine supplies the energy to drive the turbine 18. The turbine 18 then uses the energy to rotate the turbine driven shaft 8. The rotation of the turbine driven shaft 8 and the enmeshing of the gear teeth 16 and 14 is what facilitates the flywheel 2 of the present invention to rotate.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A turbine powered flywheel assembly, comprising:
a) a protective casing,
b) a generally circular flywheel at least partially disposed within said protective casing,
c) a rotating assembly on a central axis of said flywheel and structured to facilitate rotation of said flywheel,
d) a power output assembly attached to said flywheel and structured and disposed to output stored energy,
e) a driving assembly engaging said flywheel, and
f) a turbine connected in driving engagement to said driving assembly, said turbine including an exhaust intake structured to receive exhaust air and being further structured to be driven by the exhaust air.

2. A turbine powered flywheel assembly as recited in claim 1 wherein said protective casing is generally cylindrical in shape.

3. A turbine powered flywheel assembly as recited in claim 1 wherein said flywheel is composed of one-piece construction and includes gear teeth oriented in spaced relation around a perimeter of said flywheel.

4. A turbine driven flywheel assembly as recited in claim 3 where in said gear teeth on said flywheel are integrally formed with said flywheel.

5. A turbine driven flywheel assembly as recited in claims 3 wherein said gear teeth on said flywheel are separately secured to said flywheel.

6. A turbine powered flywheel assembly as recited in claim 3 wherein said driving assembly includes a turbine driven shaft.

7. A turbine powered flywheel assembly as recited in claim 6 wherein said turbine driven shaft includes gear teeth structured and oriented to come into enmeshing contact with said gear teeth on said flywheel.

8. A turbine powered flywheel assembly as recited in claim 7 wherein said gear teeth on said turbine driven shaft are integrally formed with said turbine driven shaft.

9. A turbine powered flywheel assembly as recited in claim 7 wherein said gear teeth on said turbine driven shaft are separately secured to said turbine driven shaft.

10. A turbine powered flywheel assembly as recited in claim 1 wherein said rotating assembly includes a support bearing.

11. A turbine powered flywheel assembly as recited in claim 1 wherein said power output assembly includes a power output shaft.

12. A turbine powered flywheel assembly as recited in claim 1 wherein said turbine includes an output port.

13. A turbine powered flywheel assembly, comprising:
a) a protective casing having a generally cylindrical shape,
b) a generally circular flywheel, said flywheel being at least partially disposed within said protective casing,
c) a rotating assembly, said rotating assembly including a support bearing oriented on a central axis of said flywheel,
d) a power output assembly attached to said flywheel and structured and disposed to output stored energy, said power output assembly including a power output shaft,
e) a driving assembly directly engaging said flywheel, and
f) a turbine engaging and structured to drive said driving assembly, said turbine including an exhaust intake structured to receive exhaust air and being further structured to be driven by the exhaust air.

14. A turbine powered flywheel assembly as recited in claim 13 wherein said flywheel includes gear teeth oriented in spaced relation around the perimeter of said flywheel.

15. A turbine powered flywheel assembly as recited in claim 14 wherein said power output shaft includes gear teeth oriented in spaced relation around a perimeter of one end of said power output shaft and structured and disposed to come into enmeshing contact with said gear teeth on said flywheel.

16. A turbine powered flywheel assembly as recited in claim 13 wherein said turbine further includes an output port.

17. A turbine powered flywheel assembly, comprising:
a) a protective casing having a generally cylindrical shape,
b) a generally circular flywheel, wherein said flywheel is at least partially disposed within said protective casing,
c) said flywheel being composed of one-piece construction and including gear teeth oriented in spaced relation around a perimeter of said flywheel,
d) a rotating assembly including a support bearing oriented on a central axis of said flywheel,
e) a power output assembly structured and disposed to output stored energy from within said turbine driven flywheel,
f) a driving assembly engaging said flywheel,
g) said driving assembly including a turbine driven shaft, said turbine driven shaft including gear teeth disposed around a perimeter thereof and structured and oriented to come into enmeshing contact with said gear teeth on said flywheel,
h) said driving assembly directly engaging said flywheel and structured to rotate said flywheel about a horizontal axis, and
i) a turbine engaging and structured to drive said driving assembly, said turbine including an exhaust intake structured to receive exhaust air and being further structured to be driven by the exhaust air.

18. A turbine powered flywheel assembly as recited in claim 17 wherein said rotating assembly includes a support bearing.
